(19) United States
(12) Patent Application Publication
(10) Pub. No.: US 2013/0030942 A1
(43) Pub. Date: Jan. 31, 2013

(54) USED ITEM AUCTION METHOD AND SYSTEM USING ITEM TRANSACTION INFORMATION

(71) Applicant: Jeong-hun Han, Seoul (KR)

(72) Inventor: Jeong-hun Han, Seoul (KR)

(21) Appl. No.: 13/641,133

(22) PCT Filed: Feb. 18, 2011
(86) PCT No.: PCT/KR2011/001102

§ 371 Date: Oct. 15, 2012

(30) Foreign Application Priority Data
Apr. 13, 2010 (KR) 10-2010-0033696

(51) Int. Cl. G06Q 30/08

(52) U.S. Cl. 705/26.3

(57) ABSTRACT

The present invention relates to a method and system for selling and buying items at auction using information about the purchase of items via an online shopping mall website. In order to sell and buy used items, a used item seller does not need to separately provide pieces of information about used items, and can perform a transaction for the used item using only a minimum number of inputs or actions, thus saving temporal and material costs caused by the disposal of used items. As a result, the present invention can offer convenience to the sellers of used items and can allow the buyers of used items to reasonably fix the states or prices of their desired used items and purchase relevant used items.

### TECHNICAL FIELD

The present invention relates, in general, to a method and system for selling and buying items at auction using information about the purchase of items via an online shopping mall website and, more particularly, to an auction method and system that allow a buyer who bought an item via an Internet shopping mall website to trade the item as a used item at auction via a used item auction website.

### BACKGROUND

Generally, on shopping mall websites in which items are traded over the Internet, electronic commerce (e-commerce) is performed in such a way as to list information about various types of items and allow a member who subscribed to a relevant website to buy items via web shopping. The term ‘e-commerce’ denotes activities of buying and selling items over the Internet or Personal Computer (PC) communication. E-commerce has been present in various forms such as the electronic exchange of documents between and among enterprises, or home shopping or home banking based on PC communication even before the Internet was in general use. However, as the Internet has been popularized, e-commerce has been considered in relation to transactions on the Internet.

In a narrow sense, e-commerce means that items are sold and bought in real time in a store opened as a homepage on the Internet. Items that are sold and bought include services such as remote education or medical diagnosis, as well as tangible items such as electronic parts. Furthermore, such items include digital products such as news, audio or software, which gradually occupy a large part of items.

In a wide sense, e-commerce includes activities connected with all institutions which are related to transactions, such as transaction-related providers, financial institutions, government institutions, and transportation institutions, as well as transactions with customers. The term ‘e-commerce market’ means a market in which a producer, an agent, and a customer have mutual transactions with one another over a digital communication network and refers to a virtual market as contrasted with a physical market. E-commerce influences government revenues due to variations in existing taxes and tariffs, requires the introduction of a new system to currency and payment systems, and also requires the establishment of new policies with regard to transaction authentication, transaction security, payment, customer protection, the protection of intellectual property rights, etc. An enterprise will internally improve a customer service and reduce expenses, and will externally extend markets all over the world. Economic activities conducted via e-commerce are classified as the digital economy, and it is forecasted that the real economy and the digital economy will in future form two prominent axes of economic activities. E-commerce can be regarded as a new social system and a new culture which appear with the development of information communication technology and information system development technology. This will be an opportunity to bring about remarkable changes in people's mindset and the social structure, as well as the economic lives of humankind.

Typically, in e-commerce conducted over the Internet, the selling and buying of items are performed according to fixed prices. Internet auctions are based on a cyber transaction method allowing the transaction of items to be performed between and among members in a cyber transaction place provided by a website.

A typical auction denotes a method by which a person who intends to sell a specific item invite persons who intend to buy the item, receives applications for the item at their desired prices, and makes a contract with the person who bids for the item at the highest price. The purport of the Internet auction is also similar to that of a typical auction. However, an Internet auction has the advantage of being more convenient than a typical auction in that it is not limited to a specific space like a typical auction is and it is performed in cyberspace. An Internet auction is a kind of e-commerce. That is, an Internet auction provides a service in such a way that an Internet auction company provides a cyber transaction place on a website and allows the transaction of items to be performed among members at that place. There are various types of auctions such as a reverse auction configured such that when a customer (buyer) presents an item to buy, sellers present prices for the item to the buyer, and a special price auction configured such that new items or the like of a specific enterprise are sold by auction, depending on service companies. In the case of commissions, there are various types of cases such as cases where a successful bid commission and an additional commission are charged, cases where only an additional commission is charged, and cases where no commission is charged. The types of auction services include typical auctions in which the highest bidder of a plurality of bidders makes a successful bid, instant purchasing in which a bidder makes a bid for an item at an instant purchasing price presented by a seller and then a successful bid is instantly made, fixed price selling in which a bidder makes a bid for an item at a single fixed price designated by a seller and then a successful bid is made, and a cooperative auction in which as the number of items to be bought increases, a purchasing price decreases. Further, some companies may provide a transaction protection service for the purpose of mediating the receipt and withdrawal of a payment amount in order to provide secure transactions mutually performed between and among members. Payment can be performed in various manners such as credit card payment, automatic transfer, deposit without bankbooks, Internet banking, a postal money order, or a cashier's check. Delivery is performed by a parcel delivery service. International Internet auction websites include eBay, Yahoo auction, OnSale, uBid, etc. Even in Korea, there are 10 or more specialized auction websites.

Moreover, unlike a typical auction, a reverse auction is a kind of customer-centered e-commerce in which sellers bargain with one another over prices and then a customer buys an item at the lowest price. Such a reverse auction not only can reduce the inconvenience of causing a customer to visit a plurality of Internet shopping mall websites to compare the prices of an item, but also allows the customer to feel the pleasure of bargaining when the price of the item decreases. A person who intends to participate in a reverse auction visits reverse auction websites on the Internet, carefully reads information about items, and thereafter decides on an item to buy. After the item to buy has been decided on, if the person goes to a board for bidding, and registers the model name and quantity of the item, his or her e-mail address, etc., a reverse auction starts at that time. The person visits the board at any time and checks the prices of the item presented by companies. After the auction has been terminated, the person checks the lowest bid price via his or her email, and then needs only to pay for the item using electronic payment or online transfer. A customer does not need to pay a separate commission, and the item successfully bid on by the customer is delivered to the customer.

However, such a conventional scheme is problematic in that there is the inconvenience of causing a buyer who intends to buy an item, or a seller who intends to sell a used item via a reverse auction, to separately make and list pieces of information about items after subscribing to a relevant Internet transaction website.

Moreover, there is a problem in that if a buyer who has newly bought a specific item determines that the utility of the item is low or buys a new item having a better function while using the bought item, he or she may be worried about the problem of the disposal of his or her used item. Therefore, a problem may arise in that temporal and material wastage caused by fixing a reasonable selling price for a used item and by finding an actual buyer who needs the used item must be solved. Furthermore, an environmental problem may arise together with the problems related to the wastage and recycling of resources occurring when used items are illegally disused.

### SUMMARY OF INVENTION

### Technical Problem

Accordingly, the present invention has been made keeping in mind the above problems occurring in the prior art, and an object of the present invention is to provide a used item auction method and system using item transaction information, which share information about the purchase of items via an online shopping mall website which uses a conventional reverse auction method or a conventional used item transaction method conducted over the Internet, thus activating the transaction of used items.

Another object of the present invention is to provide a used item auction method and system using item transaction information, which are configured so that when a buyer who previously bought a new item intends to sell the item as a used item, a reasonable transaction can be made via bargaining with an actual buyer who intends to buy the used item, or via an auction or a reverse auction for the used item.

### Solution to Problem

According to an aspect of the present invention for achieving the object, there is provided a used item auction method using item transaction information, comprising: (a) a used item auction server receiving used item purchase information about a desired used item from a used item purchasing member terminal; (b) the used item auction server extracting new item purchase information corresponding to the used item purchase information from a shopping information database (DB) for storing new item purchase information about new items that have been previously bought; (c) the used item auction server extracting customer information about a new item purchasing member who bought an item corresponding to the extracted new item purchase information from a customer information DB; and (d) the used item auction server sending an electronic message, which includes the used item purchase information, to a terminal of the new item purchasing member corresponding to the extracted customer information.

The new item purchase information may be new item purchase information, provision of which has been consented to by the new item buyer.

The electronic message may be one of a messenger message based on a messenger system, an email message based on an email system, and a short message based on a mobile communication system.

The electronic message may include a callback address (Uniform Resource Locator: URL) linked to the used item auction server so as to participate in an auction of the used item.

The used item auction method may further comprise (e) the used item auction server receiving auction intention information and a selling price from the new item purchasing member terminal that received the electronic message; and (f) the used item auction server transmitting both customer information about the new item purchasing member and the selling price to the used item purchasing member terminal.

The used item auction method may further comprise (g) the used item auction server receiving purchase intention information from the used item purchasing member terminal; and (h) the used item auction server transmitting both used item purchasing member information, which corresponds to the used item purchasing member terminal and is extracted from a used item purchasing member DB, and the selling price, to a financial payment system, thus enabling relevant payment to be processed.

The step (h) may comprise the used item auction server storing the selling price and the customer information about the new item purchasing member, who participate in the auction, in a deposit DB, and the used item auction method may further comprises: (i) when receiving a purchase decision from the used item purchasing member terminal, the used item auction server transferring a payment amount to an account of a relevant new item purchasing member with reference to the customer information stored in the deposit DB via the financial payment system.

The payment amount may be an amount of money obtained by deducting a commission from the selling price.

The step (b) may comprise (b-1) the used item auction server extracting similar item information, which is similar to the new item corresponding to the used item purchase information, from a comparison target item DB for storing information about items similar to any item; and (b-2) the used item auction server extracting additional information of a similar item included in the similar item information from an additional information DB for stores additional information of new items that have been previously bought, and the step (d) may comprise (d-1) the used item auction server transmitting the extracted additional information to the used item purchasing member terminal.

According to another aspect of the present invention, there is provided a used item auction system using item transaction information, comprising: a shopping information database (DB) for storing new item purchase information about new items that have been previously bought via a shopping mall website; a customer information DB for storing customer information about new item purchasing members who previously bought new items via the shopping mall website; and a used item auction server for receiving used item purchase information about a desired used item from a used item purchasing member terminal, extracting new item purchase information corresponding to the used item purchase information from the shopping information DB, extracting customer information about a new item purchasing member who bought an item corresponding to the extracted new item purchase information from the customer information DB, and sending an electronic message, which includes the used item purchase information, to a new item purchasing member terminal corresponding to the extracted customer information.

### Advantageous Effects of Invention

According to the above-described present invention, in order to sell and buy used items, a used item seller does not need to separately provide pieces of information about used items, and can perform a transaction for the used item using only a minimum number of inputs or actions, thus saving temporal and material costs caused by the disposal of used items. As a result, the present invention can offer convenience to the sellers of used items and can allow the buyers of used items to reasonably fix the states or prices of their desired used items and purchase relevant used items.

Further, the present invention is configured to sound out a seller, who has an intention to sell a used item via a used item auction website, about whether to actually sell the used item, and thereafter induce the seller to positively participate in an auction, thus contributing to the improvement of the sales rate of used items and information access rate and providing a model capable of creating various types of profit using commissions caused by auctions, the advertising of product manufacturing companies, the sponsorship of sponsors, etc.

Furthermore, the present invention can perform target transactions for the activation of transactions between sellers and buyers of used items, can decrease the time required for the transactions of used items, and can reduce the wastage of resources by recycling based on the transactions of used items.

### BRIEF DESCRIPTION OF DRAWINGS

FIG. 1 is a diagram showing a used item auction system using item transaction information according to an embodiment of the present invention; and

FIG. 2 is a flowchart showing a used item auction method using item transaction information according to an embodiment of the present invention.

### BEST MODE FOR CARRYING OUT THE INVENTION

The detailed items of other embodiments are included in the following detailed description and attached drawings.

The advantages and features of the present invention and methods of accomplishing them will be more clearly understood from the following detailed description taken in conjunction with the accompanying drawings. Reference should now be made to the drawings, in which the same reference numerals are used throughout the entire specification to designate the same or similar components.

Hereinafter, the present invention will be described in detail with reference to drawings which show a used item auction method and system using item transaction information according to embodiments of the present invention.

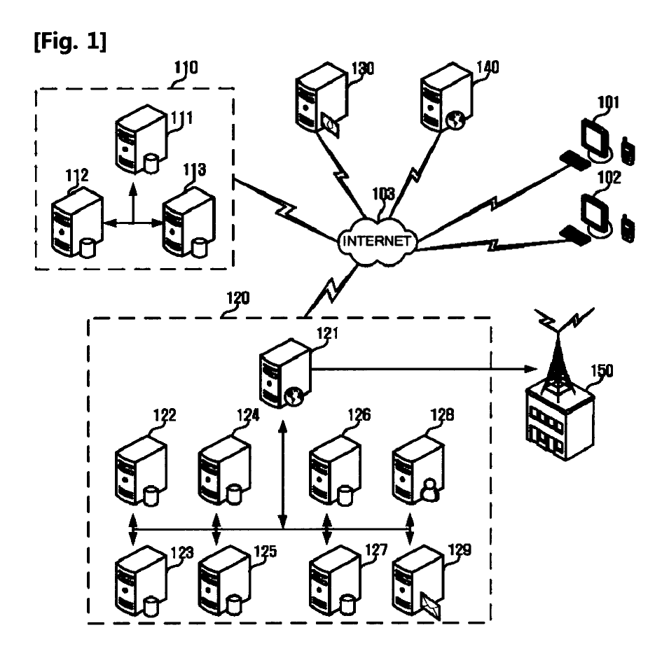

FIG. 1 is a diagram showing a used item auction system using item transaction information according to an embodiment of the present invention.

The used item auction system using item transaction information according to the embodiment of the present invention uses the Internet 103 connected in a wired or wireless manner, and a wired/wireless communication network 104 for communication with wired/wireless terminals. A shopping mall website 110 and a used item auction website 120 are connected to each other over the Internet 103. A financial payment system 130 is connected to a product manufacturing company server 140 for providing product information about various types of items so as to perform e-commerce. Any devices or systems required for the transaction of used items may be included in the used item auction system of the present invention.

A new item purchasing member terminal 102 is connected to the Internet 103 and configured to transmit or receive information required to newly buy an item via the shopping mall website 110. The new item purchasing member terminal 102 includes a medium, such as a Personal Computer (PC), a mobile phone, a smartphone or a Personal Digital Assistant (PDA), which is capable of transmitting or receiving a large amount of information in real time. Therefore, a new item purchasing member must be able to access the shopping mall website 110 using his or her terminal.

A used item purchasing member terminal 101 is connected to the Internet 103 and configured to transmit or receive information required to buy a used item via the used item auction website 120. The used item purchasing member terminal 101 includes a medium, such as a PC, a mobile phone, a smartphone or a PDA, which is capable of transmitting or receiving a large amount of information in real time. Therefore, a used item purchasing member must be able to access the used item auction website using his or her terminal. Further, the used item purchasing member terminal 101 must be able to transmit or receive information to or from the used item auction website 120 using various functions such as a text message function based on a mobile communication system 150, an email function based on an email system 129, or a messenger function based on a messenger system 128. Therefore, the used item purchasing member terminal 101 includes a terminal, which has a phone number used to receive text messages and is capable of receiving emails or messenger messages on the basis of customer information made by the used item purchasing member at the time of subscribing to the auction website as a member.

The shopping mall website 110 is a website that sells various types of items online and includes a shopping mall server 111 for providing information about various types of items and information required to buy the items to the new item purchasing member terminal 102 which is connected to the shopping mall website 10 over the Internet 103. The shopping mall server 111 includes programs, software or the like to operate a shopping mall over the Internet 103. Further, the shopping mall server 111 is connected to a customer information database (DB) 112 for inputting/outputting and storing various types of information entered by a customer at the time of subscribing to the shopping mall website as a member, and to a shopping information DB 113 for inputting/outputting and storing various types of purchase information related to items shopped by the customer on the shopping mall website.

The used item auction website 120 is a website where used items are sold and bought online and is configured to be capable of transmitting or receiving information between the new item purchasing member terminal 102 and the used item purchasing member terminal 101 which are connected to each other over the Internet 103. A used item auction server 121 is connected to the shopping mall server 111 over the Internet 103 and is configured to share information about customers and to transmit or receive item purchase information to or from both the terminal 101 of the used item purchasing member who intends to buy a used item and the terminal 102 of the new item purchasing member who bought an item via the shopping mall website 110.

The used item auction server 121 has the functions of receiving used item purchase information about a used item desired to be bought from the used item purchasing member terminal 101, extracting new item purchase information corresponding to the used item purchase information from a shopping information DB 123, extracting customer information about a new item purchasing member, who bought an item corresponding to the extracted new item purchase information, from a customer information DB 122, and sending an electronic message that includes the used item purchase information to the new item purchasing member terminal 102 corresponding to the extracted customer information.

The used item auction server 121 is connected to the customer information DB 122, the shopping information DB, and a used item purchasing member DB 124. The customer information DB 122 receives customer information about a new item purchasing member from the shopping mall server 111 and stores the customer information. The shopping information DB 123 receives information about the buying of a new item by a new item purchasing member from the shopping mall server 111 and stores the new item purchase information. The used item purchasing member DB 124 stores various types of personal information of each used item purchasing member which has been entered while the used item purchasing member undergoes a member subscription procedure using the used item purchasing member terminal 101.

Further, the used item auction server 121 is connected to a comparison target item DB 126, a deposit DB 125, and an additional information DB 127. The comparison target item DB 126 stores information about items, which are similar to or are to be (comparison targets) compared to any item or an item desired to be bought using the used item purchasing member terminal 101. The deposit DB 125 stores the selling prices of used items and customer information about new item purchasing members which participate in auctions. The additional information DB 127 stores the additional information of new items which have been previously bought by the new item purchasing members. Furthermore, the used item auction website 120 may further include a DB for transmitting or receiving and storing various types of information to or from a server having a variety of functions for the transaction of used items.

The comparison target item DB 126 is a DB for storing items, which correspond to models produced in a series of any new item, or items which correspond to models of a substitute which can replace the new item, in association with the model name of the new item. Such a comparison target item DB 126 is provided so that when any user desires to buy a specific new item, but there is no item corresponding thereto, a series model or a substitute model is provided as an item similar to or to be compared to the desired item, thus inducing more expanded shopping.

Further, the additional information stored in the additional information DB 127 includes specifications of stored items, a customer's comments left by a new item buyer who bought the new item via the shopping mall website after buying the item, information about complementary goods or substitutes such as related accessory goods, a specialist's review, the evaluation of items, etc.

Further, the used item auction server 121 is connected to the messenger system 128 for sending messenger messages to the new item purchasing member terminal 102 and/or the used item purchasing member terminal 101, and is also connected to the email system 129 for sending emails to the new item purchasing member terminal 102 and/or the used item purchasing member terminal 101. Further, the used item auction server 121 is connected to the mobile communication system 150 for sending short messages (Short Message Service: SMS) or multimedia messages (Multimedia Message Service: MMS) to mobile communication terminals included in the new item purchasing member terminal 102 and/or the used item purchasing member terminal 101.

In addition, the used item auction system using item transaction information further includes the financial payment system 130 and the product manufacturing company server 140. The financial payment system 130 is connected to the used item auction server 121 over the Internet 103 and is configured to pay for a used item from the payment account of a used item purchasing member. The product manufacturing company server 140 is connected to the used item auction server 121 over the Internet 103 and is configured to provide information about items that are sold and bought.

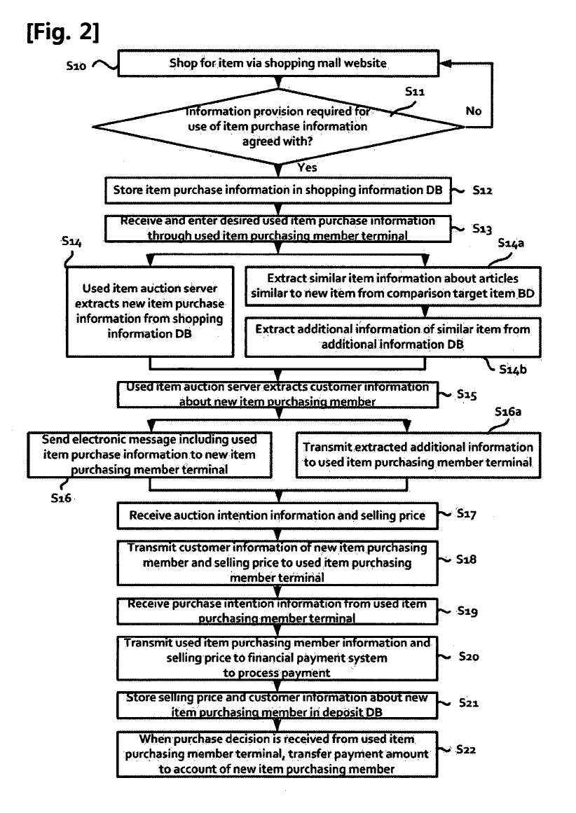

FIG. 2 is a flowchart showing a used item auction method using item transaction information according to an embodiment of the present invention.

In the used item auction method using item transaction information according to the embodiment of the present invention, a new item purchasing member who subscribed to and accesses the shopping mall website 110 shops for a desired item and decide whether to buy the item using the new item purchasing member terminal 102 at step S10. Further, after the buying of the new item has been decided on as the result of the shopping of the new item using the new item purchasing member terminal 102, the new item purchasing member checks whether to consent to the provision of information indicating that the customer information and shopping information of a member may be provided to the used item auction server 121 at step S11. If the new item purchasing member consents to information provision using the new item purchasing member terminal 102, information about the buying of the item is stored in the shopping information DB 113 at step S12. If the consent to the information provision is obtained, the used item auction server 121 extracts customer information about the new item purchasing member, and presents information about the reasonable processing of a relevant used item, the assignment of various benefits, or detailed information about the used item to the new item purchasing member terminal 102.

Therefore, after the new item purchasing member buys the item, which is sold newly by a product manufacturing company, using the new item purchasing member terminal 102 via the shopping mall website 110, he or she consents to the provision of information, thus enabling an auction for the transaction of a used item to be performed.

Next, when a used item purchasing member who subscribed to and accesses the used item auction website 120 enters information about his or her desired used item using the used item purchasing member terminal 101, the used item auction server 121 receives the used item purchase information entered through the used item purchasing member terminal 101 at step S13. In this case, information about the used item, which has been entered through the used item purchasing member terminal 101, may include the model name, model year, price, option, etc. of the used item.

Further, the used item auction server 121 extracts new item purchase information corresponding to the used item purchase information from the shopping information DB 123 which stores new item purchase information about new items which have been previously bought at step S14. Further, the used item auction server 121 extracts customer information about a new item purchasing member, who bought an item corresponding to the extracted new item purchase information, from the customer information DB 122 at step S15.

The used item auction server 121 extracts the customer information DB 112 and the shopping information DB 113 from the shopping mall server 111 over the Internet 103, and thereafter stores the DBs 112 and 113 in the customer information DB 122 and the shopping information DB 123 connected to the used item auction server 121 in advance. Alternatively, when information about a desired used item is input from the used item purchasing member terminal 101, the used item auction server 121 may extract relevant customer information and shopping information from the customer information DB 112 and the shopping information DB 113 which are related to new item purchasing members.

The used item auction website 120 must share customer information and shopping information with the shopping mall website 110 in cooperation with the shopping mall website 110. Depending on circumstances, a system including the used item auction website 120 may provide an Application Programming Interface (API), and the shopping mall system may enable the customer information DB and the shopping information DB included therein to operate in conjunction with the used item auction website 120 using the above API. Alternatively, the shopping mall system may provide an API to share the customer information DB and the shopping information DB, and the used item auction website 120 may use the above API so as to access the required customer information and shopping information using the API. In other words, the customer information DB 122 or the shopping information DB 123 may belong to the shopping mall system, and may operate in conjunction with the used item auction website in such a way as to provide or receive an API required to provide data to the used item auction system. The customer information DB 122 or the shopping information DB 123 may be transferred by the API which has been provided to or received from the shopping mall system, and may be provided as separate DBs in the used item auction system.

The used item auction server 121 sends an electronic message, including the used item purchase information, to the new item purchasing member terminal 102 corresponding to the customer information of a new item purchasing member who bought the new item corresponding to the new item purchase information at step S16. The electronic message may be sent in the form of a messenger message sent by the used item auction server 121 via the messenger system 128, an email message sent via the email system 129, or a short message (SMS message) or a multimedia message (MMS message) sent via the mobile communication system 150, thus allowing the new item purchasing member to easily recognize the relevant information. Further, the electronic message includes a callback address (Uniform Resource Locator: URL) linked to the used item auction server 121 so that the new item purchasing member can participate in the auction of a used item. The new item purchasing member terminal may access the used item auction server 121 via a web browser or another application program and participate in the auction by the user clicking or selecting the callback URL.

The used item auction server 121 receives auction intention information and a selling price from the new item purchasing member terminal 102 that received the electronic message at step S17. The auction intention information may have a form in which a message indicating that an auction confirm button has been clicked is received from the new item purchasing member terminal 102. This auction intention is expressed in such a way that the new item purchasing member has an intention to participate in the auction of the used item and enters an expected selling price into the new item purchasing member terminal 102. Further, the used item auction server 121 transmits the customer information and the selling price received from the new item purchasing member terminal 102 to the used item purchasing member terminal 101 at step S18. In this case, in order to determine whether the selling price is reasonable, information about the state of the used item currently held by the new item purchasing member is required, so that the selling price may include the state information of the used item. The state information of the used item may be transferred in the form of grade information such as A+, A0, A−, B+, B0, B−, C+, C0, C−, D+, D0, D−, and F.

Further, the used item auction server 121 receives purchase intention information from the used item purchasing member terminal 101 at step S19. The purchase intention information may have a form in which a message indicting that a purchase confirm button has been clicked is received from the used item purchasing member terminal 101. When the purchase intention of the used item purchasing member is received, the used item auction server 121 transmits used item purchasing member information, which corresponds to the used item purchasing member terminal 101 and is extracted from the used item purchasing member DB 124, and the selling price, to the financial payment system 130 connected to the Internet 103, with the result that payment is processed, at step S20. The used item auction server 121 stores the selling price of the used item and the customer information about the new item purchasing member who participates in the auction in the deposit DB 125 at step S21.

Further, when a purchase decision is received from the used item purchasing member terminal 101, the used item auction server 121 transfers a payment amount to the account of the relevant new item purchasing member via the financial payment system 130 with reference to the customer information stored in the deposit DB 125 at step S22. This is a step required to transfer a payment amount to the new item purchasing member which is a seller of the used item only when a transaction has been terminated after the used item purchasing member actually received his or her bought used item for the purpose of realizing secure transactions. The payment amount may be an amount of money obtained by deducting a commission from the selling price. Such a commission may be a fee obtained by mediating the auction of the used item traded between the new item purchasing member and the used item purchasing member on the used item auction website 120. Further, in the case of the commission, a commission caused by the transaction of an item may be charged to one or more of the new item purchasing member and the used item purchasing member. Furthermore, the used item auction website 120 can create profit by obtaining advertisements from product manufacturing companies or the like or getting a sponsorship from a sponsor or the like.

Meanwhile, when the new item purchasing member has no intention or low intention to participate in the auction, the used item auction server 121 extracts from the comparison target item DB 126 similar item information about an item that is similar to the new item and that corresponds to the used item purchase information of items which are similar to or are compared to the used item desired by the used item purchasing member at step S14a. Further, the used item auction server 121 extracts the additional information of the similar items included in the similar item information from the additional information DB 127 which stores the additional information of previously bought new items at step S14b. Furthermore, the used item auction server 121 transmits the extracted additional information to the used item purchasing member terminal 101 at step S16a.

The additional information of the comparison target items includes the specifications of the items, a customer's comments, a specialist's review, the evaluation of the items, etc. Such additional information is entered and stored by each new item purchasing member while or after the new item purchasing member buys a new item via the shopping mall website. Further, the specifications of the items are acquired from the server 140 of an affiliated product manufacturing company, and are then provided. Furthermore, in the case of the information about items, even information about new items or returned items, as well as information about used items, is provided.

The used item purchasing member provided with the information about the items participates in a transaction by comparing and referring to the comparison target items. This enables the extension of the transaction index of any items or comparison target items, which correspond to similar items, although not the used item desired by the used item purchasing member, and also enables the induction of participation in an auction, the expansion of the rate of sales, and the improvement of information access rate. That is, through this stage, if there is no item identical to an item desired by the used item purchasing member, the present invention induces the used item purchasing member to view series items similar to the desired item or substitutes for the desired item, and to purchase at least the series items or the substitutes.

Those skilled in the art will appreciate that the present invention can be implemented in other detailed forms without changing the technical spirit or essential features of the invention. Therefore, the above-described embodiments should be understood to be only exemplary in all aspects and not to be restrictive. The scope of the present invention should be defined by the accompanying claims rather than by the above detailed description, and all changes or modifications derived from the meaning and scope of the claims and equivalents thereof should be interpreted as being included in the scope of the present invention.

1. A used item auction method using item transaction information, comprising:
(a) a used item auction server receiving used item purchase information about a desired used item from a used item purchasing member terminal;
(b) the used item auction server extracting new item purchase information corresponding to the used item purchase information from a shopping information database (DB) for storing new item purchase information about new items that have been previously bought;
(c) the used item auction server extracting customer information about a new item purchasing member who bought an item corresponding to the extracted new item purchase information from a customer information DB; and
(d) the used item auction server sending an electronic message, which includes the used item purchase information, to a terminal of the new item purchasing member corresponding to the extracted customer information.

2. The used item auction method according to claim 1, wherein the new item purchase information is new item purchase information, provision of which has been consented to by the new item buyer.

3. The used item auction method according to claim 1, wherein the electronic message is one of a messenger message based on a messenger system, an email message based on an email system, and a short message based on a mobile communication system.

4. The used item auction method according to claim 1, wherein the electronic message includes a callback address (Uniform Resource Locator: URL) linked to the used item auction server so as to participate in an auction of the used item.

5. The used item auction method according to claim 1, further comprising:
(e) the used item auction server receiving auction intention information and a selling price from the new item purchasing member terminal that received the electronic message; and
(f) the used item auction server transmitting both customer information about the new item purchasing member and the selling price to the used item purchasing member terminal.

6. The used item auction method according to claim 5, further comprising:
(g) the used item auction server receiving purchase intention information from the used item purchasing member terminal; and
(h) the used item auction server transmitting both used item purchasing member information, which corresponds to the used item purchasing member terminal and is extracted from a used item purchasing member DB, and the selling price, to a financial payment system, thus enabling relevant payment to be processed.

7. The used item auction method according to claim 6, wherein (h) comprises the used item auction server storing the selling price and the customer information about the new item purchasing member, who participate in the auction, in a deposit DB, the used item auction method further comprising:
(i) when receiving a purchase decision from the used item purchasing member terminal, the used item auction server transferring a payment amount to an account of a relevant new item purchasing member with reference to the customer information stored in the deposit DB via the financial payment system.

8. The used item auction method according to claim 7, wherein the payment amount is an amount of money obtained by deducting a commission from the selling price.

9. The used item auction method according to claim 1, wherein:
(b) comprises:
(b-1) the used item auction server extracting similar item information, which is similar to the new item corresponding to the used item purchase information, from a comparison target item DB for storing information about items similar to any item; and
(b-2) the used item auction server extracting additional information of a similar item included in the similar item information from an additional information DB for stores additional information of new items that have been previously bought, and
(d) comprises:
(d-1) the used item auction server transmitting the extracted additional information to the used item purchasing member terminal.

10. A used item auction system using item transaction information, comprising:
a shopping information database (DB) for storing new item purchase information about new items that have been previously bought via a shopping mall website;
a customer information DB for storing customer information about new item purchasing members who previously bought new items via the shopping mall website; and
a used item auction server for receiving used item purchase information about a desired used item from a used item purchasing member terminal, extracting new item purchase information corresponding to the used item purchase information from the shopping information DB, extracting customer information about a new item purchasing member who bought an item corresponding to the extracted new item purchase information from the customer information DB, and sending an electronic message, which includes the used item purchase information, to a new item purchasing member terminal corresponding to the extracted customer information.
